(19) United States
(12) Patent Application Publication
(10) Pub. No.: US 2014/0026230 A1
(43) Pub. Date: Jan. 23, 2014

(54) Method, System, Login Device, and Application Software Unit for Logging in to Document Management System

(71) Applicant: Beijing Sursen International Information Technology Co., Ltd., Beijing (CN)

(72) Inventor: Donglin Wang, Beijing (CN)

(73) Assignee: Beijing Sursen International Information Technology Co., Ltd., Beijing (CN)

(21) Appl. No.: 14/034,428

(22) Filed: Sep. 23, 2013

Related U.S. Application Data
(63) Continuation-in-part of application No. 12/133,296, filed on Jun. 4, 2008.
Application No. 12/133,296 is a continuation of application No. PCT/CN2006/003297, filed on Dec. 5, 2006.
Application No. PCT/CN2006/003297 is a continuation of application No. PCT/CN2012/072602, filed on Mar. 20, 2013.

(30) Foreign Application Priority Data
Dec. 5, 2005 (CN) 200510126683.6
Dec. 9, 2005 (CN) 200510131072.0
Mar. 21, 2011 (CN) 201110067712/1

(51) Int. Cl. G06F 21/62; G06F 21/31

(52) U.S. Cl. CPC G06F 21/62; G06F 21/31
USPC 726/28

(57) ABSTRACT

The present invention provides a method, system, login device, and application software unit for logging in to a document management system. [symbol] the method includes: establishing a login device which has a unified invocation interface; invoking, by a user, the login device via an application software unit, wherein the application software unit invokes the login device via the unified invocation interface; returning, by the login device, to the application software unit, access information of a role corresponding to the user achieved after successfully logging in the document management system; accessing, by the application software unit, the document management system by using the access information.

### CROSS-REFERENCE TO RELATED APPLICATION

This application is a continuation of PCT/CN2012/072602 filed Mar. 20, 2013, which claims priority from Chinese patent application 201110067712.1, filed on Mar. 21, 2011; the entire contents of which are incorporated herein by reference for all purposes. The application is also a continuation in part of U.S. patent application Ser. No. 12/133,296 filed on Jun. 4, 2008, which is a continuation of International Application No. PCT/CN2006/003297 (filed Dec. 5, 2006), which claims priority to Chinese Application No. 200510126683.6 (filed Dec. 5, 2005) and 20051013072.0 (filed Dec. 9, 2005), the contents of which are incorporated herein by reference for all purposes.

### FIELD OF THE INVENTION

The present invention relates to the document management system technology, and more particularly, to a method, system, login device, and application software unit for logging in to a document management system.

### BACKGROUND OF THE INVENTION

The patent application for invention with the PCT application number of PCT/CN2006/003294 discloses a method and system for document data security management. To guarantee the security of objects of all levels including a document warehouse, docbase, document and page in the document management system, the abovementioned application for invention discloses a document data security management method as follows.

Several roles are created in document management system, where each role is identified with its unique ID. Each role has one or more keys. Each key corresponds to a unique access permission (view permission, write permission, re-authorization permission, and print permission, etc.), which is used for the fine-grained security access control for the document management system and objects of all levels in the document management system. For example, the said keys may be used for logging in to the document management system, viewing the document, and signing the document, respectively.

When accessing the document management system, the application software unit authenticates the user firstly. After a successful authentication, the application software unit sends the login request carrying the role information to the document management system. The document management system judges whether the login is successful according to the role information, and returns the access information, such as session channel information, to the application software unit after a successful login. The application software unit then uses the access information to access the document management system.

Existing technologies usually need to set a corresponding authentication module in the application software unit for user authentication. For example, the application software units, including the Office Automation System, need to develop an authentication module to realize a specific authentication. Hence, the user needs to modify the existing authentication module when choosing a new authentication method.

There are some other methods in the prior art. For example, an application software unit opens its own authentication module to be invoked by other application software units. However, the other application software units invoking the authentication module depends on the specific application software unit, and should he modified when the specific application software unit changes. In addition, a login device may be constructed. The user may log in through the login device, and then the login device logs in to application software units according to the mechanism of the application software units respectively. However, it cannot be known which application software units will be logged the login device cannot be developed to support unknown application software unit.

It is obvious that in the prior art the authentication module is unable to multiplex the authentication method, or costs a lot due to the large coupling, or cannot support unknown application software units. In conclusion, in the prior art, it is unable for various kinds of application software units to rapidly and efficiently log in to the document management system.

### SUMMARY OF THE INVENTION

Embodiments of the present invention provide a method and a system for logging in to the document management system, a login device and an application software unit, which make various kinds of application software units rapidly and efficiently log in to the document management system.

A method for logging in to a document management system provided includes:
establishing a login device which has a unified invocation interface;
invoking, by a user, the login device via an application software unit, wherein the application software unit invokes the login device via the unified invocation interface;
returning, by the login device, to the application software unit, access information of a role corresponding to the user achieved after successfully logging in the document management system;
accessing, by the application software unit, the document management system by using the access information;
when invoked at the first time, authenticating, by the login device, the user, and logging in to the document management system by using role information of the document management system corresponding to the user after a successful authentication; returning, by the login device, the access information corresponding to the user from the document management system to the application software unit, and storing the access information; when invoked again, retrieving, by the login device, the stored access information and returns the access information back to an application software unit who invokes.

The embodiment of the present invention also provides a system for logging in to the document management system, which includes: a document management system, at least one login device, and at least one application software unit;
each login device has a unified invocation interface; and the login device is adopted to, when invoked by a user for the first time through an application software unit, authenticate the user, log in to the document management system by using role information corresponding to the said user after a successful authentication, and store the access information returned from the document management system after a successful login; when invoked again by the user again through the same or other application software units, retrieve the stored access information and returning the access information to the same or other application software units:
the application software unit is adapted to invoke the login device via the unified invocation interface; obtain the access information provided by the current login device, and use the access information to access the document management system.

The embodiment of the present invention also provides a login device, which includes:
a unified invocation interface, adapted for invoking the login device by an application software unit;
an authentication module, adapted to perform user authentication when logged in to by a user through the application software unit at the first time;
a login module, adapted to log in to the document management system by using role information of the document management corresponding to the user after a successful authentication, and store the access information from the document management system after a successful login;
an access information processing module, adapted to retrieve the stored access information when the user logs in again through the same or other application software units, and return the access information back to the same or other application software units.

The embodiment of the present invention also provides an application software unit, which includes:
a login device invocation interface, adapted to invoke a login device via a unified invocation interface;
an access information acquisition module, adapted to obtain access information from the document management system from the login device;
a document management access module, adapted to access the document management system by using the access information.

By using the technical scheme of the embodiments of the present invention, the relationship among the user information, role information of the document management system, and the access information is established via the login device. Therefore, the user only needs to perform the authentication and login operations once when log in to the same document management system via different application software unit, which makes the role information shared better among application software units. Meanwhile, by providing the login device with unified invocation interface, any application software unit can log in through such login device, and transmit the access information via the unified interface. In this case, the authentication method is shared among application software units. Various kinds of application software units can rapidly and efficiently log in to the document management system. Furthermore, the application software unit does not need to focus on the specific authentication method.

### BRIEF DESCRIPTION OF THE DRAWINGS

FIG. 1 illustrates the flowchart of a method for logging in to a document management system provided in one embodiment of the present invention.

FIG. 2 illustrates the structure of a system for logging in to a document management system provided in one embodiment of the present invention.

FIG. 3 illustrates the structure of a login device provided in one embodiment of the present invention.

FIG. 4 illustrates the structure of an application software unit provided in one embodiment of the present invention.

### DETAILED DESCRIPTION OF THE INVENTION

The embodiments of the present invention are described more fully hereinafter with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as systems, methods or devices. The following detailed description should not to be taken in a limiting sense.

Throughout the specification and claims, the following terms take the meanings explicitly associated herein, unless the context clearly dictates otherwise. The phrase “in one embodiment” as used herein does not necessarily refer to the same embodiment, though it may. Furthermore, the phrase “in another embodiment” as used herein does not necessarily refer to a different embodiment, although it may. Thus, as described below, various embodiments of the invention may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.” The term “coupled” implies that the elements may be directly connected together or may be coupled through one or more intervening elements. Further reference may be made to an embodiment where a component is implemented and multiple like or identical components are implemented.

While the embodiments make reference to certain events this is not intended to be a limitation of the embodiments of the present invention and such is equally applicable to any event where goods or services are offered to a consumer.

Further, the order of the steps in the present embodiment is exemplary and is not intended to be a limitation on the embodiments of the present invention. It is contemplated that the present invention includes the process being practiced in other orders and/or with intermediary steps and/or processes.

The present invention is further described hereinafter in detail with reference to accompanying drawings and embodiments.

Embodiments of the present invention provide a method of logging in to a document management system. In an embodiment, a login device with a unified invocation interface is created; a user invokes the login device via an application software unit, wherein the application software unit invokes the login device via the unified invocation interface; the login device returns the access information of the role corresponding to the user achieved after the successful login to the document management system; the application software unit uses the access information to access the document management system. When invoked for the first time (for example, a user logs in to the login device through any application system unit), the login device authenticates the user, and logs in to the document management system by using the role information corresponding to the user after a successful authentication; after a successful login, the login device returns the access information of the role corresponding to the user from the document management system to the application software unit, and stores the access information; when invoked again (for example, the same user logs in to the login device through the same or other application system units), the login device retrieves the stored access information and returns the access information to the application software unit.

FIG. 1 illustrates the flowchart of a method for logging in to a document management system provided in one embodiment of the present invention. As shown in FIG. 1, the method including the following steps:

Step 101: create a login device with a unified invocation interface.

In one embodiment of the present invention, the login device may be in the form of the login component. The login device, as a unified name, is adopted in the present invention for simplicity.

Step 102: Register the login device in the computer system according to a method predetermined with each application software unit.

This step may be implemented with man methods. Three of them are listed as follows.

Method 1: Register location information of the login device in the registry of the computer system according to a method predetermined, with each application software unit. The location information may be the location information of the login device program file.

Method 2: Register the location information of the login device in a specified directory of the computer system according to a method predetermined with each application software unit.

Method 3: Install the login device in a specified directory of the computer system according to a method predetermined with each application software unit.

The location information of the login device includes: the name and/or the location of the login device. The name of the login device is used to identify the login device, and the location of the login device, which usually is the path information, is used to locate the login device.

Step 103: When the user logs in through the current application software unit, the application software unit traverses login devices registered in the computer system according to a method predetermined with the login devices, determines one login device as the current login device, and invokes the current login device through the its unified invocation interface.

In this step, the current application software unit traverses registered login devices in the computer system according to a method predetermined with the login devices. If there are multiple registered login devices, the information of the login devices traversed is provided to the user, and the one selected by the user is determined as the current login device. Another way is to select one login device randomly as the current login device or according to preset rules. If there is only one registered login device, the only one login device is determined directly as the current login device.

After the current login device is determined, the current login device is invoked, through the unified invocation interface of the login device, and the user will log in the document management system via the current login device.

Step 104: The current login device authenticates the user, and sends a login request to the document management system by using role information corresponding to the user in the document management system after a successful authentication. After a successful login, the access information returned from the document management system is provided to the current application software unit. Once obtaining the access information, the role logged in has the permission to access the document management system, and the application software unit has permissions of the logged in role.

In this step, the current login device may authenticate the user according to the stored authentication information. The login device may use many authentication methods, such as the method of user name and password, the method of user name and hardware bound, or the method of fixed password. The selection of authentication method depends on the actual needs. The authentication process is only related with the interaction between the login device and the user. The application software unit does not need to involve in the specific authentication method. Hence, the user authentication method based on the login device shields the implementation difference among different authentication methods adopted by different application software units.

The login device may store corresponding relation between the users and roles of the document management system. In this case, the current login device may obtain the role information of the document management system corresponding to the user according to the stored corresponding relation after a successful user authentication. Or, the corresponding relation also ma be stored in the application software unit or other functional units instead of the login device. In this case, the current login device may achieve the role information of the document management system corresponding to the user from the application software unit or other functional units after a successful user authentication.

When the login device provides the access information returned from the document management system to the current application software unit, it may directly send the access information returned from the document management system to the current application software unit. Or, the login device also may preset a shared storage unit with the application software unit, and store the access information returned from the document management system in the shared storage unit, from which both the login device and the application software unit may achieve the access information.

In addition, in this step, the access information may be session channel information or other information for security access. The session channel information usually includes the session ID and the session key. The session ID is the unique identifier of the session. The session key is used to authenticate the validity of the session of the user.

The session channel technology of the document management system is adopted in this embodiment. Different components or application software units may share logging in to the document management system via transferring the session key. The session channel technology can better support application software units sharing the role.

Step 105: The current application software unit uses the access information to access the document management system.

This step may be implemented with the same methods in existing technologies. No further description is discussed here.

The method may further include step 106. The current application software unit sends a logout request to the current login device when the access terminates. The current login device sends a role logout request to the document management system according to the logout request, and deletes the access information corresponding to the role after the role logs out from the document management system.

Step 106 is an optional step. When there is the shared storage unit, the access information in the shared storage unit will be deleted when the user logs out if the step 106 is executed; otherwise, the access information in the shared storage unit will not be deleted.

In practical implementation, after accessing the document management system via an application software unit, the user may access the document management system again through another application software unit. In this case, steps 103-105 or steps 103-106 are performed. If there is a shared storage unit, judge whether there is access information in the shared storage unit after step 103 is executed. If there is the access information, the current application software unit is informed to get the access information from the shared storage unit, and then step 105 or steps 105-106 are executed. if there is not the access information, steps 104-105 or steps 104-106 are executed. The above process may better support application software units share the role.

In the practical implementation, the authentication of multiple roles may be performed at one time. In this case, multiple roles log in to the document management system at the same time. That is, multiple roles correspond to the same access information.

The above embodiments describe the method for logging in to the document management system. In the following, a system for logging in to the document management system provided in one embodiment of the present invention will be described in details.

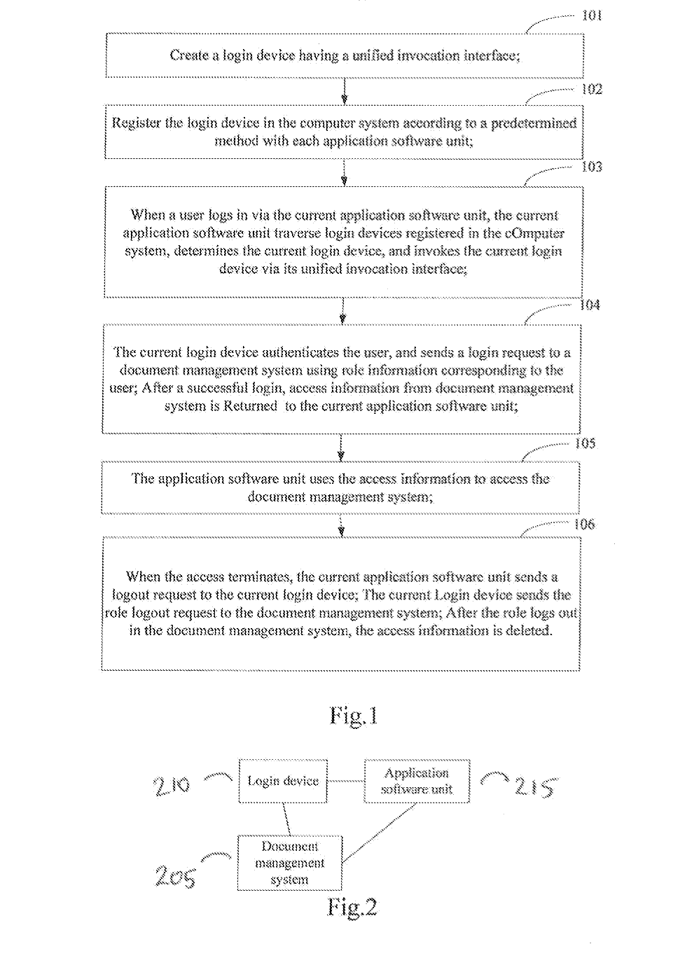

FIG. 2 illustrates the structure diagram of the system for logging in to the document management system provided in one embodiment of the present invention. As shown in FIG. 2, the system includes: a document management system 205, at least one login device 210, and at least one application software unit 215.

Each login device 210 has a unified invocation interface; and is registered in the computer system according to a method predetermined with the application software units. When invoked by a user for the first time through an application software unit 215, the login device 210 is adopted to authenticate the user, log in to the document management system by using role information corresponding to the said user after a successful authentication, and store the access information returned from the document management system 205 after a successful login; when invoked again by the user again through the same or other application software units 215, retrieve the stored access information and returning the access information to the same or other application software units 215. The operation process of the login device 210 is similar with the method described in FIG. 1. No further details will be discussed here.

The application software unit 215 is adapted to traverse the login devices 210 registered in the computer system according to a predetermined method, determine the current login device 210, invoke the current login device 210 through its unified invocation interface; obtain the access information provided by the current login device 210, and use the access information to access the document management system 205. The operation process of the application software unit may be implemented as described in FIG. 1. No further details will be discussed here.

Corresponding to the method shown in FIG. 1, the system may further include: a shared storage unit, adapted to store the access information returned from the document management system. In this case, the login device may store the access information returned from the document management system in the shared storage unit. Correspondingly, the application software unit may achieve the access information from the shared storage unit.

Corresponding to the method shown in FIG. 1, before the user authentication, the login device may be further adapted. to judge whether there is the access information in the shared. storage unit. If there is the access information in the shared storage unit, and return the access information to the same or other application software units; otherwise, authenticate the user and log in to the document management system.

Corresponding to the method shown in FIG. 1, the application software unit may be further adapted to send a logout request to the current login device when the access terminates. Correspondingly, the login device is adapted to send a role logout request to the document management system according to the logout request, and deletes the access information corresponding to the role after the role logs out from the document management system.

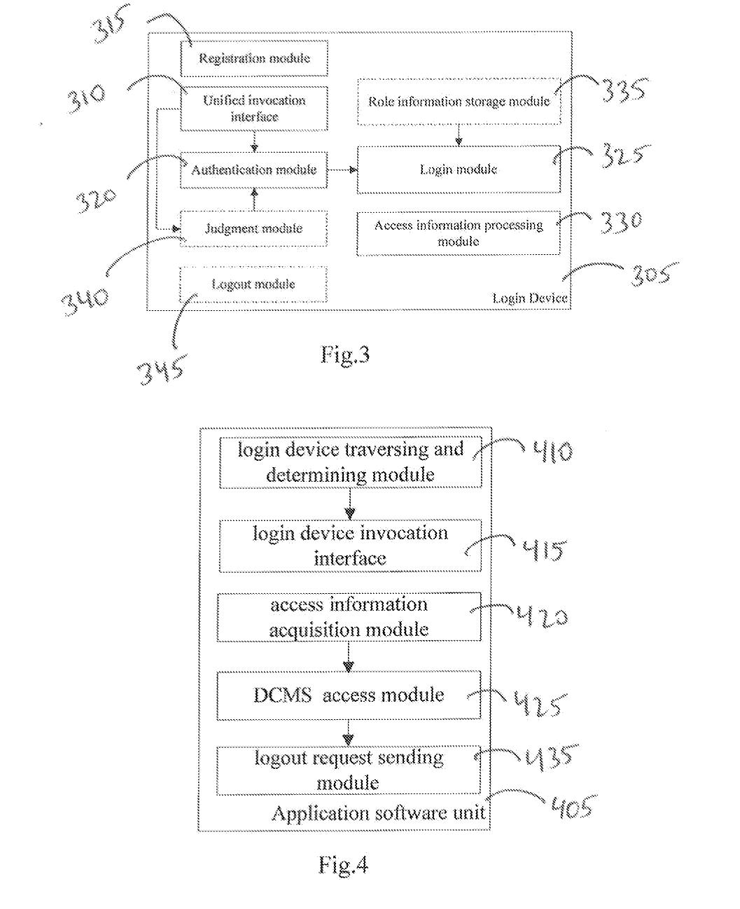

In practice, the structure of the login device in an embodiment of the present invention may be implemented in many forms. FIG. 3 illustrates one structure diagram of the login device 305 provided in an embodiment of the present invention. As shown in FIG. 3, the login device 305 includes: a unified invocation interface 310, a registration module 315, an authentication module 320, a login module 325, and an access information processing module 330.

The unified invocation interface 310 is adapted for invoking the login device 305 by an application software unit.

The registration module 315 is adapted to register the login device in the computer system according to a method predetermined with the application software unit.

The authentication module 320 is adapted to authenticate a user according to stored authentication information.

The login module 325 is adapted to log in to the document management system by using role information of the document management corresponding to the user after a successful authentication, and store the access information from the document management system after a successful login.

The access information processing module 330 is adapted to retrieve the stored access information when the user logs in again through the same or other application software units, and return the access information back to the same or other application software units.

The operation process of the registration module may be as described in the step 102. The operation process of the authentication module, the login module, and the access information processing module may be similar with the step 104.

The login device may further include: a role information storage module 335, adapted to store the corresponding relation between users and role information of the document management system. Correspondingly, the login module 325 is further adapted to achieve the role information of the document management system corresponding to the user from the role information storage module 335 after the authentication module 320 performs a successful authentication.

If there is a shared storage unit shared by the login device and the application software unit, the access information processing module 330 may store the access information in the shared storage unit. In this case, the login device 305 may further include: a judgment module 340, adapted to judge whether there is the access information in the shared storage unit, if there is, obtain the stored access information, and return the access information to the same or other application software units; otherwise, authenticate the user and log in to the document management system.

The login device may further include: a logout module 345, adapted to receive a logout request from the same or other application software units, send a role logout request to the document management system based on the logout request, and delete the access information of the document management role corresponding to the user after the document management system logs out the role.

In practice, the structure of the application software unit 405 in an embodiment of the present invention may be implemented in many forms. FIG. 4 illustrates a structure diagram of the application software unit 405 disclosed in an embodiment of the present invention. As shown in FIG. 4, the application software unit includes: a login device traversing and determining module 410, a login device invocation interface 415, an access information acquisition module 420, and a document management access module 425.

The login device traversing and determining module 410 is adapted to traverse login devices registered in the computer system according to a predetermined method with the login devices, and determine one login device as the current invoked login device.

The login device invocation interface 415 is adapted to invoke the current invoked login device via a unified invocation interface.

The access information acquisition module 420 is adapted to obtain access information from the document management system from the current invoked login device.

The document management access module 425 is adapted to access the document management system by using the access information. Specifically, the access information may be sent by the login device directly to the access information acquisition module, or be obtained by the access information acquisition module from the shared storage unit between the login device and the application software unit.

The application software unit may further include: a logout request 435 sending module, adapted to send a logout request to the login device after the access is completed.

The skilled in the art can understand that the drawings are just the schematic diagram of preferred embodiments. The modules or processes in the drawings may be unnecessary. It should be understood that the embodiments offered herein are used for explaining the present invention only and shall not be used for limiting the protection scope of the present invention.

The skilled in the art can understand that the modules of the devices in the embodiments may be distributed in devices as the description of the present embodiment, and also may be located in one or multiple devices different from the embodiments according to corresponding changes. The modules of the abovementioned embodiments may be combined into one module, or be further split into many sub-modules.

The serial number of the embodiments in the present invention is only for description, and does not indicate the merit of the embodiment.

Some of the steps in the embodiment of the present invention may be implemented via software. The corresponding software program may be stored in the readable storage medium, such as CDs and hard disks.

The above embodiments give a detailed description of the purpose, technical scheme, and beneficial effects of the present invention. The above content only includes preferred embodiments of the present invention. The content is not used to limit the protection scope of the protection. Any modification, replacement, and improvement made under the design idea and the design principle will be considered to be within the protection scope of the present invention.

1. A method for logging in to a document management system, comprising:
establishing a login device which has a unified invocation interface;
invoking, by a user, the login device via an application software unit, Wherein the application software unit invokes the login device via the unified invocation interface;
returning, by the login device, to the application software unit, access information of a role corresponding to the user achieved after successfully logging in the document management system;
accessing, by the application software unit, the document management system by using the access information;
when invoked at the first time, authenticating, by the login device, the user, and logging in to the document management system by using role information of the document management system corresponding to the user after a successful authentication; returning, by the login device, the access information corresponding to the user from the document management system to the application software unit, and storing the access information; when invoked again, retrieving, by the login device, the stored access information and returns the access information back to an application software unit who invokes.

2. The method of claim 1, further comprising:
registering at least one login device in the computer system according to a predetermined method with each application software unit;
traversing, by the application software unit, the login devices registered in the computer system according to a predetermined method, and determining one login device as the current invoked login device.

3. The method of claim 2, wherein, registering at least one login device in the computer system according to a predetermined method with the application software unit comprises:
registering the location information of the login devices in the registry of the computer system according to a predetermined method with the application software unit.

4. The method of claim 2, wherein, registering at least one login device in the computer system according to a predetermined method with the application software unit comprises:
registering the location information of the login devices in a predetermined directory of the computer system according to a predetermined method with the application software unit.

5. The method of claim 2, wherein, registering at least one login device in to the computer system according to a predetermined method with the application software unit comprises:
installing the login devices in a predetermined directory of the computer system according to a predetermined method with the application software unit.

6. The method of claim 2, wherein, determining one login device as the current invoked login device comprises: providing the information of the login devices traversed to the user, and determining the login device selected by the user as the current invoked login device.

7. The method of claim 1, wherein, before logging in to the document management system by using, role information of the document management system corresponding to the user after a successful authentication, the method further comprises:
acquiring the role information corresponding to the user according to the corresponding relation between users and role information of the document management system stored in the login device or the application software unit.

8. The method of claim 1, wherein, authenticating, by the login device, the user comprises: authenticating, by the login device, the user according to authentication information irrelevant to the application software unit and stored in the login device.

9. The method of claim 1, wherein, storing the access information comprises:
storing the access information in the shared storage unit of the login device and the application software unit;
retrieving, by the login device, the stored access information and returns the access information back to an application software unit who invokes comprises:
acquiring the access information from the shared storage unit, and returning the access information to the application software unit.

10. The method of claim 1, further comprising:
sending, by the application software unit, a logout request to the login device;
sending, by the login device, the role logout request to the document management system according to the logout request, deleting the access information of the document management role corresponding to the user after the document management system logs out the role.

11. The method of claim 1, wherein, the access information is session channel information of the document management system.

12. A login device, comprising:
a unified invocation interface, adapted for invoking the login device by an application software unit;
an authentication module, adapted to perform user authentication when logged in to by a user through the application software unit at the first time;
a login module, adapted to log in to the document management system by using role information of the document management corresponding to the user after a successful authentication, and store the access information from the document management system after a successful login;
an access information processing module, adapted to retrieve the stored access information when the user logs in again through the same or other application software units, and return the access information back to the same or other application software units.

13. The login device of claim 12, further comprising:
a. registration module, adapted to register the login device in the computer system according to a method predetermined with the application software unit.

14. device of claim 13, further comprising:
a role information storage module, adapted to store the corresponding relation between users and role information of the document management system;
the login module, further adapted to achieve the role information of the document management system corresponding to the user from the role information storage module after the authentication. module performs a successful authentication.

15. The login device of claim 14, further comprising:
a judgment module, adapted to judge whether the access information exists in the system, if the access information exists, obtain the stored access information, and return the access information to the same or other application software units; otherwise, authenticate the user and log in to the document management system.

16. The login device of claim 12, further comprising:
a logout module, adapted to receive a logout request from the same or other application software units, send the role logout request to the document management system, and delete the access information of the document management role corresponding to the user after the document management system logs out the role.

17. An application software unit, comprising:
a login device invocation interface, adapted to invoke a login device via a unified invocation interface;
an access information acquisition module, adapted to obtain access information from the document management system from the login device;
a document management access module, adapted to access the document management system by using the access information.

18. The application software unit of claim 17, further comprising:
a login device traversing and determining module, adapted to traverse the login devices registered in the computer system according to a predetermined method with the login devices, and determine one login device as the current invoked login device.

19. The application software unit of claim 18, further comprising:
a logout request sending module, adapted to send a logout request to the login device after the access is completed.
